(19) United States
(12) Patent Application Publication
(10) Pub. No.: US 2014/0273047 A1
(43) Pub. Date: Sep. 18, 2014

(54) Method of detecting Mycobacterium tuberculosis complex by cell filtrate protein 10-loaded detonation nanodiamond

(71) Applicant: NATIONAL DONG HWA UNIVERSITY, Hualien (TW)

(72) Inventors: Wen-Ping Peng, New Taipei City (TW); Po-Chi Soo, New Taipei City (TW); Ching-Jen Kung, Taipei City (TW); Kou-Hwa Chang, Taichung City (TW); Shu-Chuan Yu, Taipei City (TW); Wan-Zo Ho, Taipei City (TW)

(73) Assignee: NATIONAL DONG HWA UNIVERSITY, Hualien (TW)

(21) Appl. No.: 13/802,768

(22) Filed: Mar. 14, 2013

(51) Int. Cl. G01N 27/62

(52) U.S. Cl. CPC G01N 27/62
USPC 435/23; 435/34; 530/402

(57) ABSTRACT

A method of detecting Mycobacterium tuberculosis complex (MTBC) in a culture media is provided, in which, the culture media containing the MTBC and a biomarker, such as CFP-10, secreted from the MTBC is provided, the culture media is filtered to obtain a filtrate, detonation nanodiamond particles are mixed with the filtrate to form biomarker-loaded detonation nanodiamond particles, and a mass spectrometry analysis process is performed on the biomarker-loaded detonation nanodiamond particles for detecting the biomarker.

### BACKGROUND OF THE INVENTION

1. Field of the Invention

The present invention relates to detection of Mycobacterium tuberculosis complex, and, particularly, to a method of detecting Mycobacterium tuberculosis complex and to a cell filtrate protein 10-loaded detonation nanodiamond particle for detection of Mycobacterium tuberculosis complex.

2. Description of the Prior Art

The genus Mycobacterium encompasses approximately 140 heterogeneous species of rapid- and slow-growing bacilli. Some species of this genus cause diseases in humans and animals. The most important pathogenic species are Mycobacterium tuberculosis complex (hereinafter, referred to as “MTBC”) which can cause tuberculosis (hereinafter, referred to as “TB”). MTBC has become a significant cause of death in many developing countries and continues to be a public health problem globally. Therefore, the development of a rapid, reliable, and early diagnosis method for MTBC is crucial to prevent further spread. Conventional methods of identifying MTBC are colony morphology, pigmentation and biochemical tests, which require several weeks for adequate MTBC growth and sometimes cannot make an accurate identification of MTBC; therefore, molecular biology tools have been developed to diagnose MTBC, such as DNA hybridization (AccuProbe, Gen-Probe, San Diego, Calif.) and nucleic acid amplification (BD ProbeTec ET Direct TB system, Becton Dickinson Sparks, MD; AMTD2 Gen-Probe, Inc., San Diego, Calif.; and COBAS AMPLICOR MTB assay, Roche, Basel, Switzerland). These can quickly identify MTBC (e.g., AccuProbe took 3.5 hours, ProbeTec 3.5-4 hours, AMTD2 2.5 hours, and AMPLICOR 6-7 hours). However, they have the following shortcomings. First, long turnaround times lead to delay in reporting results. Second, it is expensive to require reagents due to cold storage and shipping. Last but not least, it is labor-intensive and expensive to extract nucleic acid, so samples are usually processed in batches in some hospitals to lower the cost.

The above-mentioned methods are suitable for both solid and liquid media, but the use of liquid cultures is recommended by the World Health Organization (WHO) for mycobacterial species identification and drug susceptibility tests in high TB burdened countries due to their rapid detection and increasing yield. Nevertheless, liquid cultures also grow nontuberculous mycobacteria (NTM), which sometime exists in the upper respiratory track and causes opportunistic infections in the immunocompromised individuals, and, therefore, a novel detection method of rapid and reliable differentiation of MTBC and NTM is still needed, for the treatment and effective control of TB.

### SUMMARY OF THE INVENTION

One objective of the present invention is to provide a method of detecting MTBC and cell filtrate protein 10-loaded detonation nanodiamond, for the detection in a rapid, specific, safe, reliable, and inexpensive way.

In one aspect, a method of detecting MTBC in a culture media is provided. The method includes steps as follows. First, the culture media containing the MTBC and a biomarker secreted from the MTBC is provided. Next, the culture media is filtered to obtain a filtrate. Detonation nanodiamond (hereinafter, referred to as “DND”) particles are mixed with the filtrate to form biomarker-loaded DND particles (hereinafter, referred to as “DNDs”). Thereafter, a mass spectrometry analysis process is performed on the biomarker-loaded DNDs for detecting the biomarker.

In another aspect, a method of detecting MTBC in a clinical isolate is provided. First, the clinical isolate is provided. The clinical isolate is cultured in a broth culture media for MTBC to secrete biomarker molecules. Thereafter, the broth culture media is filtered to obtain a filtrate which is accordingly substantially free of cells. DNDs and the filtrate are mixed together for allowing the DNDs to absorb the biomarker molecules. A mass spectrometry analysis process is performed on the DNDs absorbing the biomarker molecules, for detecting the biomarker molecules.

In still another aspect, a CFP-10-loaded DND particle for detecting a clinical isolate of MTBC in a culture media by mass spectrometry is provided. The CFP-10-loaded DND particle includes a detonation nanodiamond particle and at least CFP-10 proteins absorbed by the detonation nanodiamond particles. CFP-10 stands for cell filtrate protein 10.

In the present invention, detection of the biomarker of MTBC is achieved through detection of the biomarker absorbed on DNDs using MS analysis. As the biomarker is relatively highly concentrated on the DNDs, the mass-to-charge ratio (m/z) signal may have a relatively high intensity, leading detection in a rapid, specific, safe, reliable, and inexpensive way.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic plan view illustrating a biomarker-loaded DND particle;

FIG. 2 is a mass spectrum of cell-free filtrate from MTBC cultivated in the MGIT, analyzed by MALDI-TOF MS without DND pretreatment;

FIG. 3 is a mass spectrum of cell-free filtrate from MTBC cultivated in the MGIT, analyzed by MALDI-TOF MS with 5 nm DND pretreatment;

FIG. 4 is a mass spectrum of cell-free filtrate from MTBC cultivated in the MGIT, analyzed by MALDI-TOF MS with 50 nm DND pretreatment;

FIG. 5 is a mass spectrum of cell-free filtrate from MTBC cultivated in the MGIT without trypsin digestion on biomarker-loaded DNDs;

FIG. 6 is a mass spectrum of cell-free filtrate from MTBC cultivated in the MGIT with trypsin digestion on biomarker-loaded DNDs;

FIG. 7 is amass spectrum of tryptic peptides from supernatant solution and the CFP-10 related peptides marked with dash-line arrow;

FIG. 8 illustrates detection limit of rCFP-10 by DND MALDI-TOF MS analysis;

FIG. 9 shows mass spectra of various concentrations of rCFP-10 analyzed by MALDI-TOF MS performed on the CFP-10 loaded-DNDs;

FIG. 10 is a mass spectrum of cell-free filtrated from MTBC with 5 nm DND treatment, in which the inset photo is the SEM image of DNDs;

FIG. 11 is a mass spectrum of cell-free filtrated from MTBC with 50 nm DND treatment, in which the inset photo is the SEM image of DNDs; and

FIG. 12 is a mass spectrum of cell-free filtrated from MTBC with 100 nm HPHT ND pretreatment, in which the inset photo is the SEM image of ND particles.

### DETAILED DESCRIPTION

In one aspect, the method of detecting MTBC in a culture media according to the present invention includes steps as follows. First, the culture media containing the MTBC and a biomarker secreted from the MTBC is provided.

MTBC may be provided from a clinical isolate or a specimen, but not limited thereto. Upon cultured in a culture media, MTBC may secrete proteins including MPT45, MPT63, MPB64, MPT70, antigen 85 complex, and ESAT-6/CFP-10, which are the known major candidates used for MTBC identification and can serve as a biomarker of MTBC.

Suitable culture media may include, for example, broth culture media, Dubos' medium, Middlebrook 7H9 Broth, Proskauer and Beck's medium, Sula's medium, and Sauton's medium, but not limited thereto.

Next, the culture media is filtered to obtain a filtrate. It may be desired that the filtrate is free of cells, so as to reduce risk of TB infection during the detection procedures. The resulting filtrate may include the biomarker proteins, such as CFP-10 or others secreted from MTBC.

Thereafter, DNDs are mixed with the filtrate to form biomarker-loaded DNDs. DNDs possess properties of chemical inertness, hardness, optical transparency, and biocompatibility. DNDs can be produced by detonation of carbon-containing explosives. It is preferred that DNDs suitably usable in the present invention may have a diameter in a range from 5 nm to 50 nm. When DNDs and the filtrate are mixed together, the DNDs absorb the biomarker proteins, such as CFP-10, present in the filtrate, to form biomarker-loaded DNDs. FIG. 1 illustrates a schematic plan view of a biomarker-loaded DND particle. The surface of DND particle is rough, and at least a molecule of biomarker, such as CFP-10 and/or others, is absorbed on the DND particle. The mixing can be performed in a proper temperature not to harm the sample, such as room temperature, but not limited thereto. The time period for mixing is not specifically limited, and it may be preferably 1 hour, but not limited thereto. The biomarker-loaded DNDs-and-filtrate mixture may be further filtrated or, preferably, centrifugated to obtain the biomarker-loaded DNDs which may be further washed with, for example, deionized (DI) water.

Thereafter, a mass spectrometry analysis process is performed on the biomarker-loaded DNDs for detecting the biomarker. The mass spectrometry suitably usable in the present invention may be matrix-assisted laser desorption ionization time-of-flight mass spectrometry (MALDI-TOF MS). The biomarker-loaded DNDs are further processed for MALDI-TOF MS analysis.

The method according to the present invention can rapidly and correctly identify MTBC. The method is also safe as compared with the detection techniques using whole cells. The combination of high pressure high-temperature (HPHT) NDs with TOF mass spectrometry can also effectively detect proteins, biopolymers, DNA oligonucleotides, and multiphosphorylated peptides from complex biosamples feasible. Therefore, ND MALDI-TOF MS is a good platform to detect potential biomarkers under critical environments (for example, salt and detergent interferences, low protein concentrations) in detecting MTBC. However, it is observed that HPHT NDs of 100 nm in size can not effectively capture CFP-10 protein molecules thereon. However, the DND MALDI-TOF MS can enhance the sensitivity and credibility of detecting specific biomarker, CFP-10, which can identify MTBC from mycobacterium growth indicator tube (hereinafter referred to as MGIT) culture media.

On diamond digestion further confirms that the antigen extracted by 5 nm DNDs is CFP-10 proteins. The dot blotting method shows a positive reaction with anti-CFP-10 of DND captured proteins, which confirms that CFP-10 is presented in the medium of MGIT with MTBC growing but not with NTM growing. Compared with the commercial molecular diagnostic assays, the turnaround time of DND MALDI-TOF MS is greatly reduced from 5 hours to 1 hour and the sensitivity increases by about a factor of 2. Compared with the MALDI-TOF MS method, the DND MALDI-TOF MS analysis shows 40-fold increase in detection sensitivity of CFP-10. The concentration of rCFP-10 protein in MGIT medium for identification by DND MALDI-TOF MS may be little down to, for example, 0.09 μg/mL, but not limited thereto. The minimal concentration detectable may depend on instruments. In summary, the method according to the present invention is simple and can minimize the operator's exposure to pathogens in the clinical laboratory. Besides, the cost of DNDs in diagnosis is very low, and only little amount, such as 50 microgram (μg), is required for one sample analysis. DNDs can be directly used without surface modifications and operated in a wide pH range. The results showed 100% sensitivity and 98% specificity for identification of 500 clinical MTBC isolates.

In another aspect, a method of detecting MTBC in a clinical isolate is provided. In this method, the steps are similar to the method described above, but the clinical isolate may be obtained from a patient which may be a human or an animal, may or may not contain MTBC, and be specifically subject to a detection of biomarker molecules, such as CFP-10, for realizing whether if the patient is infected with MTBC.

Furthermore, a trypsin digestion may be optionally performed on the DNDs absorbing the biomarker, such as CFP-10, to obtain a digestion solution having fragments of the biomarker. The digestion solution is then subjected to a MS analysis, so as to identify peaks of m/z signals resulted from the fragments, for confirmation of presence of the biomarker.

The following examples serve to illustrate the invention. These examples are in no way intended to limit the scope of the methods or CFP-10-loaded DND particle.

### EXAMPLE

### Chemical and Materials

Sinapic acid (SA), alpha-cyano-4-hydroxy-cinnamic acid (α-CHCA), bovine trypsin, Tween 20, iodoacetamide, and β-mercaptoethanol were purchased from Sigma-Aldrich (St. Louis, Mo., USA). HPLC grade trifluoroacetic acid (TFA) was obtained from Alfa Aesar. HPLC grade acetonitrile, methanol, and acetone were obtained from J.T. Baker. Nonfat dry milk was from Anchor. Phosphate-buffered saline (PBS) powder was obtained from BIO BASIC. Antimouse IgG was from Jackson ImmunoResearch. CFP-10 monoclonal antibody was purchased from Novus Biologicals. Chemiluminescence reagent was from PerkinElmer. BBL MGIT, BACTEC MGIT Growth Supplement, and BBL MGIT PANTA were obtained from Becton Dickinson (Cockeysville, Md.). Nitrocellulose membrane (NC membrane) was from Amersham Biosciences. PBST is a mixture of 1× phosphate-buffered saline and 0.1% Tween 20.

### Example 1

### The Method of Detecting MBTC According to an Embodiment of the Present Invention

### 1. Specimen Collection and Processing

The specimens were digested and decontaminated by the N-acetyl-L-cysteine-4% sodium hydroxide method and concentrated by centrifugation. Cultures were performed by inoculating 0.5 milliliters (mL) of sediment into liquid culture BACTEC MGIT 960 system (Becton Dickinson, Cockeysville, Md.). The BACTEC MGIT 960 system was automatically monitored until a positive signal presented. A 1-mL portion of the MGIT cultivated medium was filtered, followed by sample preparation for DND MALDI-TOF MS or dot blotting analysis.

### 2. Sample Preparation for DND MALDI-TOF MS Analysis

The DNDs were suspended in DI water at a concentration of 1 mg/mL. The DND solution was sonicated for 5 minutes before use. A 50-μL portion of DND solution (1 mg/mL) was put to 1 ml of filtered MGIT medium. After weakly vortexing for 30 minutes at room temperature, the protein-loaded DNDs were centrifuged at 13,000 rpm for 3 minutes. The supernatant was removed, and the DNDs were additionally washed with DI water to remove residual contaminants. A 1.5-μL portion of saturated SA solvent was mixed with DNDs followed by depositing 0.8 μL of mixture solution on a plate, and then, the sample was analyzed by MALDI-TOF MS. DNDs having a diameter of 5 nm and 50 nm were utilized, respectively. The filtered liquid media of MGIT were also directly analyzed by MALDI-TOF MS as a control.

### 3. Sample Preparation for MALDI-TOF Analysis

Samples for MALDI-TOF analysis were prepared by two-layer method according to Dai et al., “Two-Layer Sample Preparation: A Method for MALDI-MS Analysis of Complex Peptide and Protein Mixtures,” Analytical Chemistry, 71, 1087-1091, 1999, to the extent that it provides exemplary procedural or other details supplementary to those set forth herein, is specifically incorporated herein by reference. The concentration of the first-layer matrix solution was 10 mg/mL SA in 60% MeOH/acetone. Then 1 μL of the solution was placed on a MALDI probe and allowed it dried to form a microcrystal layer. The concentration of the second-layer matrix solution is saturated SA in 50% acetonitrile and in 0.1% trifluoroacetic acid (TFA). Filtered MGIT medium was mixed 1:1 (v/v) with the second-layer matrix solution. Then 0.8 μL of the mixture solution was put to the top of the first matrix layer and then air dried. Before MALDI-TOF MS analysis, the whole steel plate was immersed in deionized (DI) water for 10 seconds to remove salt and contaminants. The samples were analyzed by MALDI-TOF MS after air drying.

All MALDI-TOF MS analyses were carried out using a Microflex II MALDI time-of-flight (TOF) mass spectrometer (Bruker Daltonics) equipped with a 337-nm nitrogen laser (maximum energy 150 μJ), a linear flight tube of 1.1 m and a 96-well MALDI target plate. The mass accuracy (RMS error) of TOF mass analyzer is close to 300 ppm (using linear external calibration) and the mass resolution is above 1,000 for cytochrome c (MH+12,361) in linear/positive ion mode. The instrument was calibrated with a protein mixture. Extracted supernatant proteins by nanodiamonds were analyzed in the linear mode. The accelerating voltage was set at 20 kV, and the laser radiation, pulse voltage, and detector voltage were adjusted to obtain the optimal mass resolution for all spectra. Other parameters during the operation were as follows: laser firing rate, 60 Hz; laser shots per spectrum, 100; time-lag focusing delay, 170 ns.

### 4. Results

FIGS. 2 to 4 show results of MS analysis for the filtered liquid media of MGIT without DND, with 5 nm-DNDs, and 50 nm-DNDs, respectively. FIG. 2 shows several low intensity peaks in mass spectrum. It was speculated that the low concentrations of these potential biomarkers in the cultured media led to the weak intensity of the peaks. In FIGS. 3 and 4, the intensities of the peaks were enhanced about a factor of 50 as compared with those of the peaks without 5 nm DNDs treatment, and the intensities of peaks by 5 nm DNDs pretreatment were even greater than 50 nm DNDs pretreatment. The filtered medium MGIT background was a control. The potential biomarker for differentiating MTBC from, for example, NTM, is indicated by a bracket. These results demonstrate that 5 nm DNDs is the best platform to concentrate the biomarkers in liquid media of MGIT growing mycobacterium species followed by DND MALDI-TOF MS analysis.

### Example 2

### The Method of Detecting MBTC According to an Embodiment of the Present Invention—On-Diamond Digestion

On-diamond digestion assay was modified according to Chen et al., “Solid-Phase Extraction and Elution on Diamond (SPEED): A Fast and General Platform for Proteome Analysis with Mass Spectrometry,” Analytical Chemistry, 78, 4228-4234, 2006, to the extent that it provides exemplary procedural or other details supplementary to those set forth herein, is specifically incorporated herein by reference. Proteins-loaded DNDs were incubated in 50 μL of 2% β-Mercaptoethanol/25 mM NH₄HCO₃ solution for 10 minutes, and then 380 mM iodoacetamide/200 mM NH₄HCO₃ solution was put in and incubated for 10 minutes. Subsequently, DNDs were washed with DI water and acetonitrile. 7 μL of trypsin solution (100 ng trypsin in 50 mM NH₄HCO₃) was put in and incubated for one hour at 50° C. After centrifugation at 13000 rpm for 3 minutes, DNDs and supernatant were mixed with α-CHCA matrix and analyzed by MALDI-TOF MS respectively.

All on-diamond digestion mass spectra were carried out using reflectron mode of MALDI-TOF MS. Other parameters during the operation were as follows: laser firing rate, 60 Hz; laser shots per spectrum, 100; time-lag focusing delay, 150 ns. On-diamond digestion spectra were interpreted and peak lists were generated by DataAnalysis 4.0 (Bruker Daltonics, Bremen, Germany). Searches were done by using the MASCOT 2.2.04 (Matrix Science, London, UK) against latest SwissProt database for protein identification. Searching parameters were set as follows: enzyme selected as trypsin with one maximum missing cleavage sites, species limited to Bacteria (Eubacteria), a mass tolerance was 0.3%, Protein mass was 11 kDa.

Discussion

Selection of Specific Biomarker (CFP-10) for MTBC by DND MALDI-TOF MS Analysis

Table 1 shows that four peaks were presented in most or all of these MTBC isolates. Three peaks showed frequency up to 80%, but only the peak at 10,675 m/z showed the highest intensity and the highest frequency (100%) in the cell-free filtrate from the liquid media growing MTBC (Table 1).

TABLE 1
Selected Peaks from Spectra Obtained from MTBC
Cultured in MGIT Broth
DND MALDI-TOF analysis

| m/z [Da] | intensity (%)^{a} | frequency (%)^{b} |
|---|---|---|
| 10114.31 | 37.04 | 88 |
| 10128.12 | 15.46 | 80 |
| 10675.79 | 77.12 | 100 |
| 10690.44 | 41.93 | 60 |

^{a}Averaged peak intensity from 12 MTBC isolates analyzed by DND MALDI-TOF MS.
^{b}The positive rate of the peak present in mass spectra obtained from 12 MTBC isolates.

The peak at 10,675 m/z was chosen as specific biomarker to distinguish MTBC from nontuberculous mycobacteria (NTM) in clinical specimens. In order to characterize this specific biomarker, the cell-free filtrate from the media growing MTBC was concentrated by 5 nm DNDs, followed by trypsin digestion and MALDI-TOF MS analysis. The peak at 10,675 m/z marked with a solid-line arrow shown in FIG. 5 was absent in FIG. 6 after trypsin digestion, indicating this biomarker was a protein, not a chemical compound, polysaccharide, or lipid. Because the molecular weight, Mw=10,675, is very close to theoretic molecular weight of CFP-10 protein (Mw 10794), and a notice is made to the lost of N-terminal Met reported in the literature, the theoretic Mw is turned to 10,663. This value is very close to 10,675 in DND MALDI-TOF MS analysis. The tryptic digest peptide masses (m/z) were marked as 477.02, 906.39, 1138.34, 2004.9, and 2613.48 as shown in FIG. 7. Compared with the peaks of theoretical trypsin digestion of every peptide in the SwissProt database through the Mascot software, those marked five peaks (shown in FIG. 7) result in a significant probability-based MOWSE score of 68 which indicates the peak at m/z 10,675 is a CFP-10 antigen.

CFP-10 amino acid sequence is shown as follows.

M“AEMKT”DAATLAQEAGNFER“ISGDLKTQIDQVESTAGSLQGQWRGAA
GTAAQAAVVR”FQEAANKQKQELDEISTNIR“QAGVQYSR”ADEEQQQAL
SSQMGF

Mascot analysis result is shown in Table 2.

TABLE 2
Mascot analysis result

| Start-End | Observed | Mr (expt.) | Miss | Sequence |
|---|---|---|---|---|
| 2-5 | 477.02 | 476.29 | 0 | M.AEMK.T |
| 21-44 | 2613.48 | 2612.89 | 1 | R.JSGDLKTQIDQ |
| | | | | VESTAGSLQGQ |
| | | | | WR.G |
| 27-44 | 2004.90 | 2003.89 | 0 | K.TQIDQVESTAG |
| | | | | SLQGQWR.G |
| 45-57 | 1138.34 | 1138.29 | 0 | R.GAAGTAAQAA |
| | | | | VVR.F |
| 78-85 | 906.39 | 905.89 | 0 | R.QAGVQYSR.A |

The CFP-10 protein is secreted from MTBC and involved in the pathogenicity of MTBC by inhibiting lipopolysaccharide (LPS)-induced production of reactive oxidative species (ROS). In order to confirm the CFP-10 were present in the samples containing MTBC not NTM, the cell-free filtrates with 5 nm DNDs processing were analyzed by dot blotting using anti-CFP-10 monoclonal antibody. The dot blotting result showed a positive reaction with anti-CFP-10 antibody, indicating that CFP-10 was secreted in the medium of MGIT growing MTBC not NTM (not shown). Together, the specific biomarker CFP-10 could be used to identify MTBC from clinical specimens by DND pretreatment followed by MALDI-TOF MS analysis.

Detection Limit of Specific Biomarker CFP-10 from MGIT Broth

The detection limit of CFP-10 in MGIT medium by DND MALDI-TOF MS was measured using serial 2-fold dilution of recombinant CFP-10 (rCFP-10) proteins in MGIT medium. The rCFP10 proteins were diluted from 14.4 to 0.04 μg/mL. The 100 microliters (μL) of MGIT medium and rCFP10 proteins were mixed with 50 μL of 5 nm DNDs and incubated for 30 minutes. Subsequently, the DNDs absorbing proteins were analyzed by MALDI-TOF MS and confirmed by dot blotting using anti-CFP-10 monoclonal antibody. The optimal detection limit by dot blotting method is found to be 0.18 μg/mL, whereas the detection limit of MALDI-TOF MS (without DND pretreatment) is 3.6 μg/mL. The minimal concentration of rCFP-10 protein in MGIT medium for identification by DND MALDI-TOF MS is 0.09 μg/mL, as shown in FIG. 8. In FIG. 8, the serial dilution of rCFP-10 was analyzed by MALDITOF MS (ii) or DND MALDI-TOF MS (iii) and confirmed by dot blotting using anti-CFP-10 antibody (i). The peak of rCFP-10 at 14,410 m/z shown in mass spectra is marked with +; − indicates no peak. FIG. 9 shows Mass spectra of various concentrations of rCFP-10 analyzed by MALDI-TOF MS performed on the CFP-10 loaded-DNDs. The above results indicate that the DND MALDI-TOF MS analysis shows the best detection sensitivity as compared to that of dot blotting method and conventional MALDI-TOF MS analysis. Here, it is shown that DND MALDI-TOF MS is a fast and easy method by greatly shortening the turnaround time to 1 hour.

Dot Blotting

A one-μL portion of MGIT medium containing native or recombinant CFP-10 was loaded on nitrocellulose membrane (NC membrane). After air drying, the NC membrane was incubated in the blocking solution (5% nonfat dry milk in PBST) for 1 hour. Subsequently, the membrane was incubated with monoclonal anti-CFP10 for 1 hour, followed by wash with PBST for 15 minutes three times. The membrane was incubated with antimouse IgG conjugated horseradish peroxidase (HRP) for 1 hour. After it was washed with PBST, the enhanced chemiluminescence (ECL) reagent was put in and incubated for 2 minutes. The intensity of the dot was analyzed by the gel catcher 2850 chemiluminescence camera system (CLUBIO, Taipei, Taiwan).

Protein Capture Ability with Different Sized NDs and Surface Morphology of Diamond Nanocrystalline

The capture ability of 5 nm DNDs is better than 50 nm DNDs in detecting CFP-10 proteins in MGIT media as shown in FIGS. 10 to 12. The arrow indicates the CFP-10 peak. The 50 nm DNDs show singly and doubly charged albumin proteins peaks in FIG. 11. According to the scanning electron microscopy (SEM) images shown in FIGS. 10 to 12, it is inferred that the gaps between porous structures of aggregated 5 nm DNDs are very small as compared to the size of albumin proteins. The 50 nm DNDs have similar surface structure and morphology of 5 nm DNDs, but the gaps of the aggregated structure of 50 DNDs are bigger to allow the capture of albumin proteins easier. Meanwhile, it is noticed that the CFP-10 peak intensities of mass spectra by 5 nm DNDs and by 50 nm DNDs are almost the same, but more peaks are shown in the range from m/z 5000-15,000 by 5 nm DNDs, which indicates that the protein capture ability is better than 50 DNDs due to less albumin proteins interference. FIG. 12 exhibits the use of high-pressure high-temperature (HPHT) 100 nm NDs for mass analysis, and it is observed that 100 nm HPHT NDs could not capture the CFP-10 proteins, which is because the functional groups (CH—, OH—, NH—, CO—, COOH—) on 5 nm DND surfaces show high abundance in measured absorption spectra as compared to 100 nm HPHT NDs.

Moreover, the SEM image of 100 nm HPHT NDs shows a disperse structure which is very different from that of 5 and 50 nm DNDs, because 5 and 50 nm DNDs have the oxygen containing functional groups and graphitic materials. Therefore, the 5 nm DNDs was chosen as a nice platform to concentrate the CFP-10 biomarker without albumin interference. Besides, conventional treatment of DNDs including carboxylation and oxidization in strong acids also showed no obvious difference in mass spectra analysis. The 5 nm DNDs can be directly used without any treatments, and proteins can be absorbed by 5 nm DNDs in a dilute solution within a wide pH range.

Screen of Clinical Specimens by DND MALDI-TOF MS

A total of 500 consecutive clinical specimens subjected to routine mycobacteria identification were analyzed. A total of 42 specimens showed positive signals reported by the BACTEC MGIT 960 system, followed by DND MALDI-TOF MS analysis. Among the specimens identified by culture and biochemical methods, a total of 13 specimens were reported to contain MTBC strains and 29 specimens were reported to contain NTM strains. Compared with the culture and biochemical methods, 13 MTBC-containing MGIT medium and 1 NTM-containing MGIT medium showed the peak at 10,675 m/z by DND MALDI-TOF MS. However, 28 NTM-containing MGIT medium did not show the CFP-10 protein peak. Results from DND MALDI-TOF MS showed that the sensitivity is 100%, the negative predictive value is 100%, the specificity is 98%, and the positive predictive value is 93%. Only one specimen was reported as a false-positive by DND MALDI-TOF MS. It was speculated that there was mixed culture of fast growing NTM with MTBC which was a slow growing strain. The conventional biochemical diagnosis could not distinguish the mixed mycobacterial culture in broth which needed to be confirmed by culture on solid agar media or molecular diagnosis. The cross-reactivity has been reported by immunological method to detect ESAT-6/CFP-10 because some NTM clinical isolates produced CFP-10-like proteins which had different molecular weights from CFP-10. It could be differentiated by DND pretreatment coupled with high resolution mass spectrometry, e.g. FTICR and Oribtrap mass spectrometers.

Soo et al., “Detonation Nanodiamonds for Rapid Detection of Clinical Isolates of Mycobacterium tuberculosis Complex in Broth Culture Media,” Analytical Chemistry, 84, 7972-7978, 2012, to the extent that it provides exemplary procedural or other details supplementary to those set forth herein, is specifically incorporated herein by reference.

### CONCLUSION

In the present invention, a combination of DNDs and MALDI-TOF MS analysis can easily detect secretory biomarker, such as CFP-10 protein, of MTBC. The detection limit of DND MALDI-TOF MS analysis is approximately 90 ng/mL without any amplification procedure. The method is more sensitive than the dot blotting method. The 5 nm DNDs can be directly used without any preparation procedures. The filtered MGIT liquid media minimizes the operator's exposure to pathogenic bacteria. This method is safe, reliable, and inexpensive and greatly reduces the turnaround time in detecting TB. Beside, sample enrichment and purification for MS analysis can be achieved.

Those skilled in the art will readily observe that numerous modifications and alterations of the device and method may be made while retaining the teachings of the invention. Accordingly, the above disclosure should be construed as limited only by the metes and bounds of the appended claims.

1. A method of detecting Mycobacterium tuberculosis complex in a culture media, comprising:
providing the culture media containing the Mycobacterium tuberculosis complex and a biomarker secreted from the Mycobacterium tuberculosis complex;
filtering the culture media to obtain a filtrate;
mixing detonation nanodiamond (DND) particles with the filtrate to form biomarker-loaded DND particles; and
performing a first mass spectrometry analysis process on the biomarker-loaded DND particles for detecting the biomarker.

2. The method according to claim 1, wherein the Mycobacterium tuberculosis complex is provided from a clinical isolate.

3. The method according to claim 1, wherein the biomarker is cell filtrate protein 10 (CFP-10).

4. The method according to claim 3, wherein, the CFP-10 is allowed to generate an ion having a mass-to-charge ratio (m/z) of 10,675±15.

5. The method according to claim 1, wherein the biomarker-loaded DND is purified by centrifugation and washing before the step of performing the mass spectrometry analysis process on the biomarker-loaded DND for detecting the biomarker.

6. The method according to claim 1, wherein the culture media comprises a broth culture media.

7. The method according to claim 1, wherein the DND particles have a particle size in a range from 5 nm to 50 nm.

8. The method according to claim 1, wherein the filtrate is substantially free of cells.

9. The method according to claim 1, further comprising:
performing a trypsin digestion on the biomarker-absorbed DND to obtain a digestion solution having fragments of the biomarker; and
performing a second mass spectrometry analysis process on the digestion solution to identify peaks of m/z signals resulted from the fragments to confirm presence of the biomarker.

10. A method of detecting Mycobacterium tuberculosis complex (MTBC) in a clinical isolate, comprising:
providing the clinical isolate;
culturing the clinical isolate in a broth culture media for MTBC to secrete biomarker molecules;
filtering the broth culture media to obtain a filtrate substantially free of cells;
mixing detonation nanodiamond (DND) particles with the filtrate for allowing the DND particles to absorb the biomarker molecules; and
performing a first mass spectrometry analysis process on the DND particles absorbing the biomarker molecules for detecting the biomarker molecules.

11. The method according to claim 10, wherein, when a peak of mass-to-charge ratio (m/z) signal at m/z 10,675 present in a mass spectrum resulted from the mass spectrometry analysis, the presence of Mycobacterium tuberculosis complex in the clinical isolate is determined to be positive.

12. The method according to claim 10, wherein the DND particles each have a particle size in a range from 5 nm to 50 nm.

13. The method according to claim 10, wherein the DND particles are purified by centrifugation and washing before the step of performing the first mass spectrometry analysis process on the DND particles absorbing the biomarker molecules for detecting the biomarker molecules.

14. The method according to claim 10, wherein the biomarker molecules include cell filtrate protein 10 (CFP-10) molecules.

15. The method according to claim 14, further comprising:
performing a trypsin digestion on the DND particles absorbing the CFP-10 to obtain a digestion solution having fragments of the CFP-10; and
performing a second mass spectrometry analysis process on the digestion solution to identify peaks of m/z signals resulted from the fragments for confirmation of presence of the CFP-10.

16. A cell filtrate protein 10 (CFP-10)-loaded detonation nanodiamond (DND) particle for detecting a clinical isolate of Mycobacterium tuberculosis complex in a culture media by mass spectrometry, comprising:
a detonation nanodiamond particle; and
at least a molecule of CFP-10 absorbed by the detonation nanodiamond particle.

17. The CFP-10-loaded DND particle according to claim 16, wherein the CFP-10-loaded DND particle gives a mass-to-charge ratio (m/z) signal of 10,675±15 in a first mass spectrometry analysis process.

18. The CFP-10-loaded DND particle according to claim 16, wherein the CFP-10 is secreted from Mycobacterium tuberculosis complex.

19. The CFP-10-loaded DND particle according to claim 16, wherein the DND particle has a particle size in a range from 5 nm to 50 nm.
